(19) United States
(12) Patent Application Publication
(10) Pub. No.: US 2013/0037252 A1
(43) Pub. Date: Feb. 14, 2013

(54) SMART HVAC SYSTEM HAVING OCCUPANT DETECTION CAPABILITY

(71) Applicants: Gregory A. Major, Farmington Hills, MI (US); Thomas A. Jones, Macomb, MI (US); Therese A. Tant, Royal Oak, MI (US); Bahram Khalighi, Troy, MI (US); Taeyoung Han, Bloomfield Hills, MI (US); Alan L. Browne, Grosse Pointe, MI (US); Nancy L. Johnson, Northville, MI (US); Nilesh D. Mankame, Ann Arbor, MI (US)

(72) Inventors: Gregory A. Major, Farmington Hills, MI (US); Thomas A. Jones, Macomb, MI (US); Therese A. Tant, Royal Oak, MI (US); Bahram Khalighi, Troy, MI (US); Taeyoung Han, Bloomfield Hills, MI (US); Alan L. Browne, Grosse Pointe, MI (US); Nancy L. Johnson, Northville, MI (US); Nilesh D. Mankame, Ann Arbor, MI (US)

(73) Assignee: GM GLOBAL TECHNOLOGY OPERATIONS LLC, DETROIT, MI (US)

(21) Appl. No.: 13/209,299

(22) Filed: Aug. 12, 2011

(51) Int. Cl. B60H 1/00; F24F 11/00

(52) U.S. Cl. 165/202; 165/237

(57) ABSTRACT

A smart HVAC system adapted for selectively regulating fluid flow into a space generally includes an HVAC system including at least one active vent, a preferably variable blower fluidly coupled thereto, and at least one sensor associated with each vent, wherein the sensor is operable to cause the associated vent to shift between opened and closed conditions, and/or preferably the blower output to change, when an occupant is autonomously detected within at least a portion of the space.

### BACKGROUND OF THE INVENTION

1. Field of the Invention

The present invention relates to heating, ventilation, and cooling (HVAC) systems, and more particularly, to a smart HVAC system having the capability to detect the presence of an occupant, and modify operation in accordance therewith.

2. Discussion of Prior Art

HVAC systems have long been used to condition an enclosed space fluidly coupled thereto, by pulling air from the space and/or a fresh air supply, treating (heating, cooling, humidifying, dehumidifying, etc.) the air as it flows through one or more components of the system, and then discharging the treated air through one or more air vents or registers back into the space. The air vents typically present covers that function to throw the air as desired. Triggered by a temperature-based sensor, conventional HVAC systems typically produce a set flow rate and operate irrespective of whether an occupant is within the space. By failing to consider occupancy of the space, conventional HVAC systems present inefficiencies, an unnecessarily large carbon footprint, excess wear on component parts, and increased costs associated therewith.

### SUMMARY OF THE INVENTION

The present invention concerns a smart HVAC system operable to adjustably treat a space based upon occupancy. By selectively closing one or more air vents and/or modifying output when a designated portion of the space is unoccupied, the inventive system is useful for reducing carbon footprint and energy consumption. As such, in an automotive setting, the system is further useful for increasing fuel economy, and/or improving the comfort rating for those portions of the interior cabin having an occupant. Where active materials are incorporated, the invention is also useful for improving packaging options, reduces functionally equivalent mass, noise (both acoustically and with respect to EMF), and complexity/number of moving parts, in comparison to traditional electro-mechanical systems.

In general, the invention comprises an HVAC system fluidly coupled to the space, and including a plurality of vents, a controller, and a plurality of occupant detection sensors. Each vent is fluidly coupled to a generally separate portion of the space. The controller is communicatively coupled to the HVAC system and operable to control fluid flow between the space and vents, on an individual basis. The occupant detection sensors are operable to detect a presence of an occupant within each portion of the space, and communicatively coupled to the controller, so as to inform the controller of any presence. Thus, the HVAC system, controller, and sensors are cooperatively configured to deliver treated fluid to at least one of the portions only when an occupant is detected therein.

Other aspects and advantages of the present invention, including preferred configurations and methods utilizing shape memory wire actuators, and a multi-louver cover, latching and overload protection mechanisms, and more will be apparent from the following detailed description of the preferred embodiment(s) and the accompanying drawing figures.

### BRIEF DESCRIPTION OF THE SEVERAL VIEWS OF THE DRAWING

A preferred embodiment(s) of the invention is described in detail below with reference to the attached drawing figures:

FIG. 1 is a perspective view of an interior cabin defining plural zones defined in part by the driver and front passenger seats, and fluidly coupled to an HVAC system presenting a plurality of vents serving the zones, wherein an occupant detection sensor is disposed within each seat and communicatively coupled to the HVAC system, and particularly illustrating in enlarged caption view an active vent cover, in accordance with a preferred embodiment of the invention;

FIG. 2a is a plan view of a vehicle defining an interior cabin demarking driver, front, and rear zones, and including an HVAC system presenting a plurality of vents serving the zones, occupant detection sensors disposed in each zone and communicatively coupled to the HVAC system, wherein occupants are present throughout and the HVAC system fully serves each zone, in accordance with a preferred embodiment of the invention; and

FIG. 2b is a plan view of the vehicle shown in FIG. 2a, wherein occupants are present within and the HVAC system serves half of each zone, in accordance with a preferred embodiment of the invention.

### DETAILED DESCRIPTION OF THE PREFERRED EMBODIMENT(S)

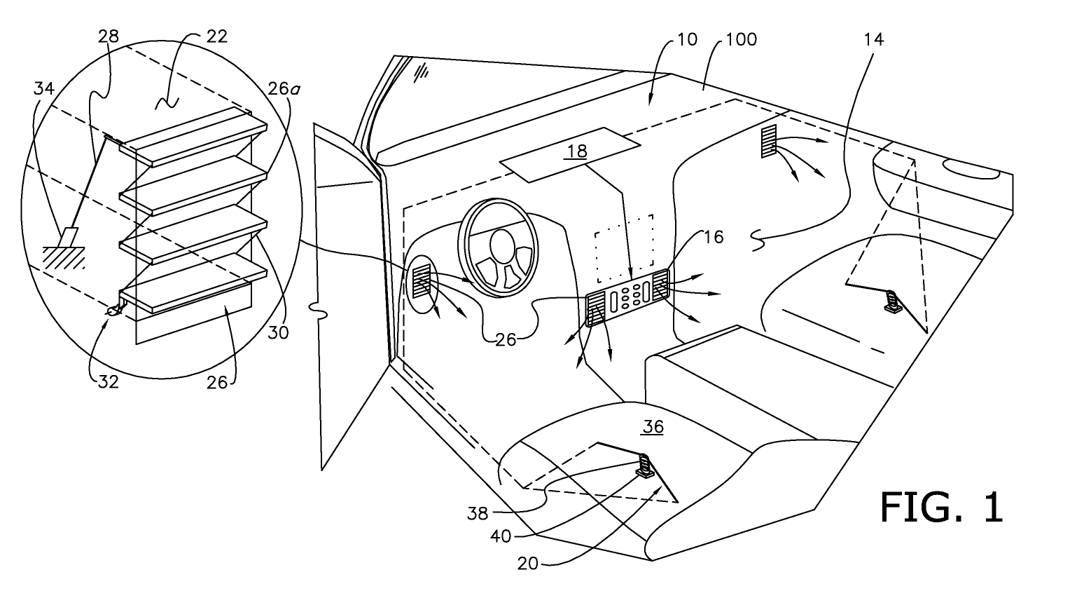

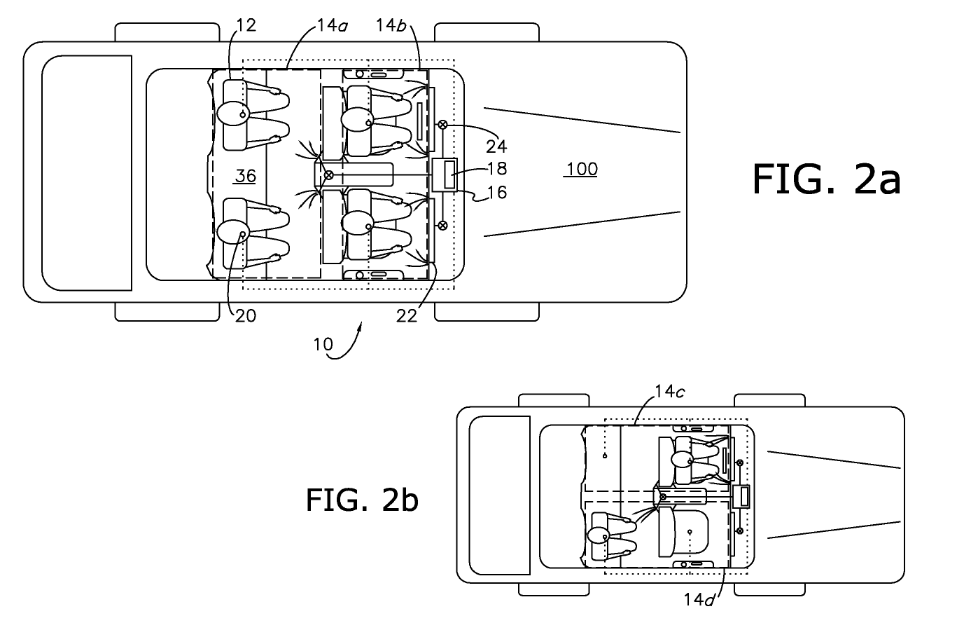

The present invention concerns a smart HVAC system 10 operable to detect the presence of an occupant 12 within a space 14 to be treated, and autonomously modify its output and/or configuration accordingly. It will be understood by those skilled in the art that various changes may be made and equivalents may be substituted for elements thereof without departing from the scope of the invention. The system 10 is described and illustrated (FIGS. 1-2b) herein, in an automotive setting; however, it is certainly within the ambit of the invention to apply the benefits and advantages of the system 10 to other settings, such as for example, with respect to airplane or residential/commercial HVAC systems. More particularly, the invention provides means for determining the presence of an occupant 12 within a controlled space 14, and selectively allowing or restricting (e.g., increasing or reducing) the flow of treated air into at least a portion the space 14, wherein selectivity is triggered by detection of the occupant 12.

The inventive system 10 includes an HVAC system 16, a controller 18 communicatively coupled to the HVAC system 16 and having stored thereupon for processing an actuation module, and at least one sensor 20 operable to detect the presence of an occupant 12 and communicatively coupled to the controller 18 (FIGS. 1-2b). It is appreciated that the HVAC system 16 and controller 18 may be combined. In the preferred embodiment, the HVAC system 16 includes a plurality of vents (i.e., airflow conduits or ports) 22 fluidly coupled to and intermediate at least one blower 24 and a generally separate portion of the space 14. That is to say, each vent 22 primarily influences that portion of the space 14 immediately adjacent thereto, and more particularly is the predominate cause of the air quality, temperature, and flow characteristics of the portion, where it is appreciated that the other vents 22 and the ambient environment adjacent to the space 14 (e.g., through the vehicle glazing for example) also influence the characteristics of the portion. As such, generally separate portions are defined by that thermal dynamic or physical boundary in which adjacent vents 22 transfer primary influence. More preferably, the portions are curtained so as to further localize treatment.

In FIGS. 2a,b, the interior cabin of a vehicle 100 defines the space 14, and the HVAC system 16 exemplarily comprises six vents 22 that define two laterally distinct zones 14a,b and two longitudinally distinct zones 14c,d. Together the zones 14a-d define generally separate front-driver, front-front passenger, arrear-driver, and arrear-front passenger portions of the space 14. In each portion, an occupant detecting sensor 20 monitors to determine the presence of an occupant 12. For example, the sensor 20 may be configured to detect the weight, heat dissipation, or exhalation of the occupant 12, and as such may present a pressure sensor disposed within each seat of the vehicle 100, an infrared detector, and/or a carbon dioxide sensor. When a presence is determined, the sensor 20 instructs the controller 18 to activate the HVAC system 16 so as to treat only the occupied portion(s). To that end, the vents 22 are shiftable between opened and closed conditions, and the blower(s) 24 is preferably manipulable.

More particularly, an autonomously adjustable cover 26 is connected and preferably sealed to each vent 22 at the outlet. For example, to save space, the cover 26 may present a multi-louver configuration, wherein a plurality of louvers 26a are inter-linked, and conjunctively actuated, so as to be caused to move congruently and in unison (FIG. 1). In this configuration, adjacent louvers 26a may be connected by a four-bar linkage system. An actuator 28 is drivenly coupled to the louvers 26a and operable to cause the cover 26 to shift between the opened and closed conditions. The actuator 28 may be mechanical, electro-mechanical, or active-material based. The controller 18 is operable to activate the actuator 28 when instructed and may be wirelessly coupled or connected thereto via hard-wire.

In the preferred embodiment, the controller 18 is also communicatively coupled to a blower 24 having a variable drive. The blower 24 as such, is operable to deliver variable output flow rates. In an automotive embodiment, for example, the HVAC system 16 may include first and second blowers 24 (FIGS. 2a,b) having dual climate control functionality. Here, the controller 18 is operable to activate one or both of the blowers 24 separately, depending upon whether and where an occupant 12 is detected. In one sampling, the blowers 24 and four vents 22 cooperatively presented an output flow rate capability range of 115-230 cubic feet per minute (cfm). From the viewpoint of a driver, it was observed that an output flow rate of 155 cfm with only the two vents adjacent the driver portion in the opened condition produced an enhanced cooling performance when compared to a baseline rate of 230 cfm with all four vents in the opened condition. By localizing the cooling in this manner, it was further observed that air velocity at the driver was increased from 0.7 m/s to 1.0 m/s, and the air temperature at the driver was further cooled to 16.6° Celsius down from 17° Celsius.

In a preferred embodiment, active material actuation is used, among other ways, to shift the cover 26 to the opened and/or closed conditions, or sense the occupant 12 more efficiently than conventional actuators and sensors, as previously presented. An active material actuator 28 or sensor 20 may either individually or in combination with traditional means of actuation provide a separate function or assist on the same function (such as to boost the force level beyond that which could be provided by the traditional actuator when required).

As used herein the term “active material” shall be afforded its ordinary meaning as understood by those of ordinary skill in the art, and includes any material or composite that exhibits a reversible change in a fundamental (e.g., chemical or intrinsic physical) property, when exposed to an external signal source. Thus, active materials shall include those compositions that can exhibit a change in stiffness properties, shape and/or dimensions in response to the activation signal, which can take the type for different active materials, of electrical, magnetic, thermal and like fields. Suitable active materials for use with the present invention include those that can be used as actuators and/or to sense the presence of an occupant, including but not limited to shape memory alloys (SMA), electroactive polymers (EAP), ferromagnetic SMA's, and piezoelectric composites, as further described below, as well as, shape memory polymers (SMP), shape memory ceramics, electrorheological (ER) compositions, magnetorheological (MR) compositions, dielectric elastomers, and other recognized active materials.

SMA in wire form, for example, may be used to drive the cover 26 to one of the opened and closed conditions by taking advantage of its shape memory characteristics, wherein the term “wire” shall be construed broadly to include other equivalent tensile configurations, such as strips, braids, cables, chains, etc. More particularly, an SMA wire 28 may be coupled to the louvers 26a (FIG. 1) and communicatively coupled to a power source (such as the vehicle charging system) operable to deliver an activation signal thereto. The power supply may be regulated by a PWM, regulator, or power resistor in-series. For example, in the case of actuators comprising thermally activated shape memory material, a current can be supplied by the power supply to effect Joule heating, when demanded by the controller 18. More preferably, to help guard against overheating, the supply may be regulated to cyclically provide power to the actuator 28; however, it is appreciated that this may cause slight movement (e.g., flutter and/or buffeting) in the cover 26.

In FIG. 1, when caused to undergo a fundamental change as previously described, the wire 28 shortens to pull the louvers 26a open. Where the associated blower 24 is not turned off (e.g., where the system 10 utilizes a single blower 24), it is appreciated that the actuator 28 must generate enough force to maintain the achieved condition. To that end, it is appreciated that exemplary actuator wires 28 may present stress and strain values of 170 MPa and 2.5%, respectively, so as to result in a sealing force of 2N, when activated. It is appreciated that SMA wires having diameter sizes of 0.012, 0.015, and 0.02 mm present a maximum pull force of 1250, 2000, and 3,560 grams, respectfully. The actuator 28 is preferably configured, such that 2.5 to 12 V, and 2 amps of current are provided for actuation. In as much as a change in dimension (e.g., constriction), and not shape memory is used to drive the cover 26, it is appreciated that EAP in the form of rolled or thin strips of dielectric elastomers and piezoelectric uni-morphs or bi-morphs, both of which could provide rapid, reversible, and field strength proportional displacement may be used in place of SMA. Moreover, it is contemplated that other active material actuator configurations, such as torque tubes coupled with an antagonistically biased torsion springs may be implemented to effect rotational motion.

Where a two-way shape memory is provided, the wire 28 functions to return the cover 26 to the previous condition, when deactivated; otherwise, a biasing mechanism 30 is added to the system 10 and functions to return the louvers 26a to the normal (e.g., opened for driver portion, and closed for front-passenger, and rear portions) condition, when the wire 28 is deactivated. For example, the links between louvers 26a may present elastic members that work to pull the cover 26 shut (FIG. 1). As a result, a closed condition is maintained in the power-off state such that a fail close configuration is provided. Alternatively, the louvers 26a may be configured to open away from the space 14 and against fluid flow, so that the blower 24 acts to seal the cover 26 in the closed condition.

A latching mechanism 32 is preferably used to hold the cover 26 in the achieved condition, when the active material element 28 is deactivated. For example, a pawl pivotally coupled to adjacent fixed structure may be configured to engage a prong fixedly attached to the cover 26, only when the cover 26 achieves the opened condition (FIG. 1). Alternatively, a ratchet (not shown) operable to effect one way motion and maintain the cover 26 in one of a plurality of intermediately opened conditions may be employed. It is appreciated that an additional active material element, such as an SMA wire (not shown) may be used to release the pawl from the prong, or disengage the ratchet, when return is desired.

Finally, the SMA wire actuator 28, in FIG. 1, is preferably coupled to a load limit protector 34. The protector 34 is configured to present a secondary output path for the wire 28, when exposed to the signal but prevented from the desired motion. This, it is appreciated, provides strain/stress relief, and thereby increase the life of the actuator 28. That is to say, it is appreciated that when an active material undergoes transformation, but is prevented from undergoing the resultant physical change (e.g. heating a stretched SMA wire above its transformation temperature but not allowing the wire to revert to its unstressed state), detrimental effects to material performance and/or longevity can occur. In the present invention, for example, it is foreseeable that the cover 26 could by constrained from moving when actuated, either by the occupant 12 or another form of impediment. For example, the protector 34 may include an extension spring placed in series with the wire 28, and opposite the cover 26; the spring is stretched to a point where its applied preload corresponds to the load level where it is appreciated that the actuator 28 would begin to experience excessive force if blocked.

With respect to the sensor 20, active material actuation may be used to sense and/or inform the controller 18 of the presence. For example, a piezoelectric load cell may be disposed within a floor or seat, so as to receive the weight of an occupant 12, when entering the space 14. More particularly, the piezoelectric element may be used to convert a change in pressure to electricity, and cause a signal to be sent to the controller 18 or HVAC system 16 directly (e.g., to activate the actuator 28 of the cover 26), when compressed by the occupant 12. A detailed discussion of piezoelectric composites and their function is provided below.

In another example, an SMA wire may be positioned and oriented to receive the weight of the occupant 12, so as to undergo a change in stress, when the occupant 12 enters the space 14; here, it is appreciated that the electrical resistance of an SMA element is directly proportional to the stress load it sustains. To that end, and as shown in FIG. 1, for example, an SMA wire 20 in a bow string configuration may be disposed within the base 36 of a seat, fixedly attached to the frame thereof, and bolstered by a spring biased trestle 38, so as to tension the wire 28. The preferred trestle 38 requires a minimum threshold weight (e.g., 100 N) for compression, so that the controller 18 is triggered when it is likely that an occupant 12 is in the space 14, and not when miscellaneous small objects, such as purses, files, books, or newspapers are placed on the seat, for example. When the occupant 12 sits on the base 36, the wire 20 is caused to undergo a change (decrease, as illustrated) in stress. A constantly monitored feedback signal picks up the change in stress, as a change in resistance and informs the controller 18. Finally, a hard stop 40 is preferably provided to prevent damaging the wire 28.

Shape memory alloys (SMA's) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. The term “yield strength” refers to the stress at which a material exhibits a specified deviation from proportionality of stress and strain. Generally, in the low temperature, or martensite phase, shape memory alloys can be plastically deformed and upon exposure to some higher temperature will transform to an austenite phase, or parent phase, returning to their shape prior to the deformation.

Shape memory alloys exist in several different temperature-dependent phases. The most commonly utilized of these phases are the so-called martensite and austenite phases discussed above. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}). Activation may be effected by temperature change caused by electric current signalization (e.g, through electric leads (not shown) connected to the vehicle charging system and battery), or other physical or chemical conversion.

When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the shape.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, super-elastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

It is appreciated that SMA's exhibit a modulus increase of 2.5 times and a dimensional change of up to 8% (depending on the amount of pre-strain) when heated above their Martensite to Austenite phase transition temperature. It is appreciated that thermally induced SMA phase changes are one-way so that a biasing force return mechanism (such as a spring) would be required to return the SMA to its starting configuration once the applied field is removed. Joule heating can be used to make the entire system electronically controllable. Stress induced phase changes in SMA are, however, two way by nature. Application of sufficient stress when an SMA is in its Austenitic phase will cause it to change to its lower modulus Martensitic phase in which it can exhibit up to 8% of “superelastic” deformation. Removal of the applied stress will cause the SMA to switch back to its Austenitic phase in so doing recovering its starting shape and higher modulus.

Ferromagnetic SMA's (FSMA's), which are a sub-class of SMAs, may also be used in the present invention. These materials behave like conportional SMA materials that have a stress or thermally induced phase transformation between martensite and austenite. Additionally FSMA's are ferromagnetic and have strong magnetocrystalline anisotropy, which permit an external magnetic field to influence the orientation/fraction of field aligned martensitic variants. When the magnetic field is removed, the material may exhibit complete two-way, partial two-way or one-way shape memory. For partial or one-way shape memory, an external stimulus, temperature, magnetic field or stress may permit the material to return to its starting state. Perfect two-way shape memory may be used for proportional control with continuous power supplied. External magnetic fields may be produced by soft-magnetic core electromagnets in automotive applications, though a pair of Helmholtz coils may also be used for fast response.

Suitable piezoelectric materials include, but are not intended to be limited to, inorganic compounds, organic compounds, and metals. With regard to organic materials, all of the polymeric materials with non-centrosymmetric structure and large dipole moment group(s) on the main chain or on the side-chain, or on both chains within the molecules, can be used as suitable candidates for the piezoelectric film. Exemplary polymers include, for example, but are not limited to, poly(sodium 4-styrenesulfonate), poly (poly(vinylamine)backbone azo chromophore), and their derivatives; polyfluorocarbons, including polyvinylidenefluoride, its co-polymer vinylidene fluoride (“VDF”), co-trifluoroethylene, and their derivatives; polychlorocarbons, including poly(vinyl chloride), polyvinylidene chloride, and their derivatives; polyacrylonitriles, and their derivatives; polycarboxylic acids, including poly(methacrylic acid), and their derivatives; polyureas, and their derivatives; polyurethanes, and their derivatives; bio-molecules such as poly-L-lactic acids and their derivatives, and cell membrane proteins, as well as phosphate bio-molecules such as phosphodilipids; polyanilines and their derivatives, and all of the derivatives of tetramines; polyamides including aromatic polyamides and polyimides, including Kapton and polyetherimide, and their derivatives; all of the membrane polymers; poly(N-vinyl pyrrolidone) (PVP) homopolymer, and its derivatives, and random PVP-co-vinyl acetate copolymers; and all of the aromatic polymers with dipole moment groups in the main-chain or side-chains, or in both the main-chain and the side-chains, and mixtures thereof.

Piezoelectric materials can also comprise metals selected from the group consisting of lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals. Suitable metal oxides include SiO₂, Al₂O₃, ZrO₂, TiO₂, SrTiO₃, PbTiO₃, BaTiO₃, FeO₃, Fe₃O₄, ZnO, and mixtures thereof and Group VIA and IIB compounds, such as CdSe, CdS, GaAs, AgCaSe₂, ZnSe, GaP, InP, ZnS, and mixtures thereof. Preferably, the piezoelectric material is selected from the group consisting of polyvinylidene fluoride, lead zirconate titanate, and barium titanate, and mixtures thereof.

Electroactive polymers include those polymeric materials that exhibit piezoelectric, pyroelectric, or electrostrictive properties in response to electrical or mechanical fields. An example of an electrostrictive-grafted elastomer with a piezoelectric poly(vinylidene fluoride-trifluoro-ethylene) copolymer. This combination has the ability to produce a varied amount of ferroelectric-electrostrictive, molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity (for large or small deformations), a high dielectric constant, and the like. In one embodiment, the polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or imventance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Suitable algorithms, processing capability, and sensor inputs are well within the skill of those in the art in view of this disclosure. This invention has been described with reference to exemplary embodiments. Modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A smart system adapted to adjustably treat a space, so as to reduce carbon footprint and energy consumption, said system comprising:
an HVAC system fluidly coupled to the space, and including at least one vent, wherein each vent primarily influences a generally separate portion of the space;
a controller communicatively coupled to the HVAC system and operable to control fluid flow between the space and vent, individually; and
at least one occupant detection sensor operable to detect a presence of an occupant within each portion of the space, and communicatively coupled to the controller,
said HVAC system, controller, and sensor being cooperatively configured to deliver treated fluid to at least one of said portions only when an occupant is detected within said at least one of said portions.

2. The system as claimed in claim 1, wherein the HVAC system further includes at least one blower fluidly coupled to each vent and producing an output flow rate, and the controller is communicatively coupled to said at least one blower and operable to manipulate the output flow rate.

3. The system as claimed in claim 1, wherein each vent presents an outlet cover shiftable between opened and closed conditions, so as to allow and occlude fluid flow, respectively.

4. The system as claimed in claim 3, wherein the HVAC system further includes at least one active material element drivenly coupled to each cover, communicatively coupled to the controller, and operable to undergo a reversible change in fundamental property when exposed to an activation signal, and the change is operable to cause or enable the cover to shift to one of the opened and closed conditions.

5. The system as claimed in claim 4, wherein the active material is selected from the group consisting essentially of shape memory alloys, ferromagnetic shape memory alloys, shape memory polymers, piezoelectric materials, electroactive polymers, and magnetostrictives.

6. The system as claimed in claim 3, wherein the cover includes a plurality of inter-linked louvers operable to cooperatively present the opened and closed conditions.

7. The system as claimed in claim 4, wherein the HVAC system further includes a biasing mechanism drivenly coupled to the cover, and operable to cause the cover to shift to the other of the opened and closed conditions, when the change is reversed.

8. The system as claimed in claim 4, wherein the HVAC system further includes a latching mechanism coupled to and configured to selectively engage the cover, so as to retain the cover in said one of the opened and closed conditions, when the change is reversed.

9. The intake as claimed in claim 4, wherein the HVAC system further includes a load limit protector coupled to and configured to present a secondary output path for the element, when the element is exposed to the signal and the cover is prevented from shifting to said one of the open and closed conditions.

10. The system as claimed in claim 1, wherein at least one of said plurality of sensors includes at least one active material element operable to undergo a reversible change in fundamental property when exposed to an activation signal, and the element is used to determine the presence.

11. The system as claimed in claim 10, wherein the sensor includes a piezoelectric element operable to detect a change in pressure caused by the presence.

12. The system as claimed in claim 10, wherein the sensor includes a shape memory alloy wire positioned and oriented so as to undergo a change in stress caused by the presence.

13. The system as claimed in claim 12, wherein the wire is pre-loaded by a spring biased trestle.

14. The system as claimed in claim 10, wherein a predetermined minimum threshold is used to determine the presence.

15. The system as claimed in claim 1, wherein the space is an interior cabin defined by a vehicle, the HVAC system includes a plurality of vents defining a plurality of portions formed by laterally distinct driver, and front passenger zones.

16. The system as claimed in claim 1, wherein the space is an interior cabin defined by a vehicle, the HVAC system includes a plurality of vents defining a plurality of portions formed by longitudinally distinct front and rear cabin zones.

17. The system as claimed in claim 1, wherein the space is an interior cabin defined by a vehicle, the HVAC system includes a plurality of vents defining front-driver, arrear-driver, front-front passenger, and arrear-front passenger portions formed by longitudinally distinct front and rear cabin zones and laterally distinct driver, and front passenger zones.

18. The system as claimed in claim 1, wherein the portions are curtained so as to localize treatment.

19. The system as claimed in claim 2, wherein each vent presents an outlet cover shiftable between opened and closed conditions, so as to allow and occlude fluid flow, and communicatively coupled to the controller, and the controller is operable to selectively modify the output flow rates, and shift the covers.

20. The system as claimed in claim 19, wherein the space is an interior cabin defined by a vehicle, the portions include laterally distinct driver and front passenger portions, and the vents, blowers, and controller are cooperatively configured to deliver 230 cubic feet per minute to the space, when an occupant is detected in each of the zones, and 155 cubic feet per minute to the space, when an occupant is detect in only one of the zones.
